(19) United States
(12) Patent Application Publication
(10) Pub. No.: US 2022/0213255 A1
(43) Pub. Date: Jul. 7, 2022

(54) AMINE-INITIATED POLYOLS AS NON-EMISSIVE CATALYSTS IN HR FOAM

(71) Applicant: Covestro Intellectual Property GmbH & Co. & KG, Leverkusen (DE)

(72) Inventors: Stefan Lindner, Remscheid (DE); Klaus Lorenz, Dormagen (DE)

(21) Appl. No.: 17/607,656

(22) PCT Filed: Jun. 24, 2020
(86) PCT No.: PCT/EP2020/067632

§ 371 Date: Oct. 29, 2021

(30) Foreign Application Priority Data
Jul. 1, 2019 (EP) 19183588.3

(51) Int. Cl. C08G 18/50; C08G 65/26

(52) U.S. Cl. CPC C08G 18/5021; C08G 65/2624

(57) ABSTRACT

A process for producing an amine-based polyol by reacting a tertiary amine with various epoxides in two or more steps. The present disclosure also relates to the amine-based polyol obtained by this process and the use of the amine-based polyol in the production of polyurethanes, wherein the polyurethanes are preferably synthesized based on toluene diisocyanate (TDI) and are preferably molded foams.

### CROSS REFERENCE TO RELATED APPLICATIONS

This application is a U.S. national stage application, filed under 35 U.S.C. § 371, of International Application No. PCT/EP2020/067632, which was filed on Jun. 24, 2020, and which claims priority to European Patent Application No. 19183588.3 which was filed on Jul. 1, 2019. The contents of each are hereby incorporated by reference into this specification.

### FIELD

The present invention relates to a process for producing an amine-based polyol by reacting a tertiary amine with various epoxides in two or more steps. The invention also relates to the amine-based polyol obtained by this process and the use of the amine-based polyol in the production of polyurethanes, wherein the polyurethanes are preferably synthesized based on toluene diisocyanate (TDI) and are preferably molded foams.

### BACKGROUND

The production of polyurethanes by reacting a reaction mixture of polyisocyanates with polyols, catalysts and optionally with blowing agents, such as water, additives and/or auxiliaries, is generally known. Polyurethanes may be produced inter alia as rigid foams or as flexible foams. Flexible polyurethane foam is understood to mean polyurethane foam which offers a low resistance to compressive stress, which is open-cell, air-permeable and reversibly deformable. Flexible polyurethane foam can be produced, inter alia, by polymerizing the reaction mixture in a mold; these are referred to as molded foams. The reaction mixture may be cured either with or without external heating after foaming, depending on the process this is referred to as hot-cure foam or cold-cure foam.

TDI-based flexible polyurethane foam, especially cold-cure foam, is an essential component of upholstery, for example seat cushions for the automotive industry. Polyurethane foam, which is used as upholstery, should have a pleasantly soft feel and good long-term use properties. The long-term use properties are represented in particular by the compression set after exposure of the foam to heat and moisture, the so-called humid aging. Furthermore, particularly when using flexible polyurethane foams as (car seat) upholstery material, low emissions of volatile substances are important. The VDA 278 test is usually used to determine emissions. The VDA 278 test is a thermal desorption process for determining organic emissions from non-metallic materials at elevated temperatures. The samples are heated and the emitted substances are cryofocused with a stream of inert gas into a cold trap and then analyzed. In order to determine the proportion of volatile organic substances (VOC), the sample is heated to 90° C. When determining the VOC, volatile amines can also be captured. The target value of all amines in the VOC is ≤50 mg/kg.

However, not only the polyurethane foam has to meet certain requirements, but also the production thereof. An economical and safe manufacturing process is desirable. The economic viability of the production process depends, inter alia, on the foaming behavior of the reaction mixture for the polyurethane foam. The period from the beginning of the mixing of the reaction mixture to the end of the rise process of the polyurethane foam is called the rise time. Ideally, the rise time is only long enough to fill the entire mold, but otherwise short, i.e. the reaction mixture foams up rapidly and, for example in a foam mold process, only needs to remain in the mold for a relatively short period of time, before the largely cured cold foam part can be released from the mold.

The speed of foam formation can be influenced by catalysts. Particularly in the production of cold-cure polyurethane foam, however, the catalysis of the blowing and crosslinking reaction must be carefully coordinated, since otherwise an unstable foam is obtained that tends to collapse or the result is a molded part that is too closed-cell. In the production of flexible polyurethane foam in the cold-cure foam process, tertiary amines are usually used as catalysts (Oertel (ed.), Kunststoff Handbuch, Polyurethane [Plastics Handbook, Polyurethanes], 3rd edition, chapter 5.3). However, such amine catalysts have the disadvantage that they outgas from the flexible polyurethane foam and cause undesirable emissions. To avoid these emissions, low molecular weight catalysts have been developed that are integrated into the structure of the polyurethane. These so-called non-emissive catalysts have, for example, hydroxyl groups that react with the isocyanate. The type and number of hydroxyl groups in such a catalyst can also influence the rise time of a polyurethane foam. Conventional low molecular weight non-emissive catalysts also influence the properties of the flexible polyurethane foam, particularly resulting in poor humid aging values for flexible polyurethane foams; this applies in particular to TDI-based flexible polyurethane foams.

WO 2015/153316 discloses starter molecules for the production of polyurethane foams which are synthesized from a tertiary amine and a polyhydric alcohol, glycidyl ether or epoxide. The tertiary amines have two substituents, each of which has either terminal hydroxyl groups or primary amines. The document does not deal with possible sagging or collapsing of polyurethane foams.

EP 1 878 492 B1, EP 1 977 825 B1 and EP 1 977 826 B1 refer to catalysts composed of diaminoethyl ethers, which are substituted with ether or ester groups, for the production of polyurethane gels or foams. Catalysts are disclosed which are obtained by reacting N,N,N′-trimethylbis(aminoethyl) ether with glycidyl ethers or glycidyl esters. The documents do not disclose any emission values for volatile amines of the polyurethane foam.

EP 2 104 696 refers to the production of polyurethane products, wherein a mixture of amine-based polyols and urea is used as catalyst. The catalyst mixture should result in a reduced emission of volatile substances and at the same time have good catalytic properties.

There is a need for non-emissive catalysts which do not adversely affect the foaming behavior of the compositions for obtaining a flexible polyurethane foam and the mechanical properties of the flexible polyurethane foam, in particular which do not impair humid aging. The resulting flexible polyurethane foam should have a core density according to DIN EN ISO 845 from 10/2015 in the range of 25 to 90 kg/m³, a compression hardness according to DIN EN ISO 3386-1 from 10/2015 in the range of 2 to 12 kPa, a tensile strength according to DIN EN ISO 1798 from 04/2008 in the range of 100 to 250 kPa and an elongation at break according to DIN EN ISO 1798 from 04/2008 in the range of 100 to 250%. There is also a need for flexible polyurethane foams that have comparatively low emissions of volatile organic substances in accordance with the VDA 278 test standard.

### SUMMARY

The object of the present invention was to provide a non-emissive catalyst for the production of flexible polyurethane foam which does not retard the foaming behavior of a flexible polyurethane foam and does not lead to sagging of the flexible polyurethane foam obtained after foaming. Furthermore, a flexible polyurethane foam comprising the amine-based polyol should have low emissions, particularly of low molecular weight amines according to the test standard VDA 278, and good humid aging properties. Good humid aging properties is intended to be understood as a humid aged load loss (HALL test) of −10% to 20% and a humid aged compression set 50%/22 h/70° C. (HACS test) test of 0% to 40%. In particular, a TDI-based flexible foam comprising the polyol according to the invention should have the properties mentioned above.

This object was achieved by a process for the production of an amine-based polyol for the production of flexible polyurethane foam, comprising the following steps
a) reacting an amine of the general formula (I)

R¹₂N—(CH₂)ₙ—NH₂ (I)
where R¹ is in each case a different or the same C₁ to C₁₀ alkyl radical and n is an integer from 1 to 10,
with an epoxide A,
wherein the epoxide A and the amine are used in a molar ratio from 10:1 to 50:1, and
the reaction is conducted until at least 90% by weight of the epoxide A used has reacted, so that an intermediate is obtained,
b) reacting the intermediate with an epoxide B, which is different from epoxide A,
   wherein epoxide B is used in an amount which corresponds to a molar ratio of the epoxide to the
   amine from 8 to 40:1, and
   the reaction is conducted until at least 90% by weight of the epoxide B used has reacted, so that the amine-based polyol is obtained.

It has been found, surprisingly, that the amine-based polyols according to the invention result in an advantageous foaming behavior of the reaction mixture and the flexible polyurethane foam obtained does not sag after foaming. In addition, the flexible polyurethane foams had good humid aging values and low emissions according to the test standard VDA 278.

### BRIEF DESCRIPTION OF DRAWINGS

FIG. 1 shows the results of the rise profile measurements for TDI-based PUR foams.

FIG. 2 shows the results of the rise profile measurements for MDI-based PUR foams.

### DETAILED DESCRIPTION

The amine-based polyol according to the invention is obtained by a polymerization process in which various epoxides are reacted successively with an amine of the general formula (I)

R¹₂N—(CH₂)ₙ—NH₂ (I)

In the amine of the general formula (I), R¹ is preferably in each case the same C₁ to C₃ alkyl radical and n is an integer from 2 to 6, where R¹ is more preferably in each case a methyl radical. In a preferred embodiment, the amine of the general formula (I) is 3-dimethylamino-1-propylamine.

In step a) of the process according to the invention, the amine of the general formula (I) is reacted with an epoxide A, the epoxide A preferably being propylene oxide. The epoxide and the amine of the general formula (I) are preferably reacted in a molar ratio from 20:1 to 50:1, more preferably 30:1 to 50:1. The reaction is conducted until at least 90% by weight, preferably at least 95% by weight, more preferably at least 98% by weight, of the epoxide A used has reacted and an intermediate is obtained.

In step b) of the process according to the invention, the intermediate obtained in step a) is reacted with an epoxide B, the epoxide B preferably being ethylene oxide. The epoxide and the intermediate are reacted in a molar ratio from 8:1 to 40:1, preferably in a molar ratio from 8:1 to 35:1, more preferably 8:1 to 30:1. The reaction is conducted until at least 90% by weight, preferably at least 95% by weight, more preferably at least 98% by weight, of the epoxide B used has reacted.

The reaction rate of the respective epoxide can be assessed by the pressure decay rate in the closed reaction vessel when reacting reactants that are gaseous at the reaction temperature. If the pressure drops at a rate of less than 30 mbar/h after completion of the metered addition of an epoxide block during the post-reaction phase, it can be safely assumed that at least 90% of the epoxide used has reacted. If a catalyst is used in step a) and/or step b), it is advantageous to separate it off by work-up steps, for example by neutralizing a basic catalyst with acid and then filtering off the salts formed, before the amine-based polyol is added to conversion steps to form polyurethane foams.

In a preferred embodiment, the epoxide A is propylene oxide and the epoxide B is ethylene oxide. The reaction in steps a) and/or b) is preferably carried out in the presence of a catalyst and/or in steps a) and/or b) and/or after completion of step b) an antioxidant is used. If a basic catalyst is used, an antioxidant is advantageously added only after it has been neutralized or separated off. Step b) is considered to have ended when at least 90% by weight of the epoxide B used has reacted. In the polymerization process described above for producing the amine-based polyol according to the invention, the two hydrogen atoms of the tertiary amine are each replaced by a polyol chain. However, due to the kinetics of the polymerization process, it cannot be assumed that the polyol chains each have the same structure, i.e. the same length or the same degree of polymerization. Furthermore, rearrangement reactions at the nitrogen atoms may also result in intra- and intermolecular redistributions of the radicals bonded to these atoms. For this reason, the exact structure of the amine-based polyol of the present invention cannot be shown. Theoretically, the amine-based polyol has the general formula (II)

R¹₂N—(CH₂)ₙ—N(—R²—H)(—R³—H) (II)

where

R¹ is in each case a different or the same unsubstituted C₁ to C₁₀ alkyl radical,

n is an integer from 1 to 10, and

—R² and —R³ each consist of structural units which can be attributed to different epoxides, preferably to propylene oxide and ethylene oxide. In this case, —R²— and —R³— are preferably each structural units of the following formula (III)

—([PO]−[EO])−H (III)

where

[PO] is a polyether fragment which can be attributed to an epoxide A, preferably essentially to propylene oxide, and

[EO] is preferably a polyol fragment which can be attributed to an epoxide B, different from epoxide A, preferably essentially to ethylene oxide.

The isocyanate index (also index) indicates the percentage ratio of the amount of isocyanate actually used to the stoichiometric amount of isocyanate groups (NCO amount), i.e. that amount calculated for the conversion of the OH equivalents:

Index=[(amount of isocyanate used)/(amount of isocyanate calculated)]•100

The invention further relates to the amine-based polyol which is obtained or can be obtained by the process according to the invention. The invention also relates to the use of the amine-based polyol in the production of flexible polyurethane foam, particularly in the production in a cold-cure foam process. When using the amine-based polyol, furniture upholstery, textile inserts, mattresses, automobile seats, headrests, armrests, sponges, roof linings, door side panels, seat covers or structural elements are preferably produced.

The invention further relates to a flexible polyurethane foam obtained or obtainable by reacting a composition comprising or consisting of
an isocyanate-reactive component A1 comprising or consisting of compounds having isocyanate-reactive hydrogen atoms and/or a filled polyol;
a further isocyanate-reactive component A2, different from A1;
a component A3 comprising or consisting of at least one blowing agent;
optionally a component A4 comprising or consisting of auxiliaries and additives; and
a component B comprising or consisting of at least one aromatic polyisocyanate; preferably toluene diisocyanate;
a component C comprising or consisting of an amine-based polyol, obtained or obtainable by the process according to the invention described above,
   wherein the reaction is carried out at an isocyanate index of 70 to 120.

The composition preferably comprises or consists of
from 65 to 95 parts by weight of component A1, wherein component A1 preferably comprises 5 to 60 parts by weight, based on the mass of component A1 and A2, of a filled polyol,
from 0.1 to 5 parts by weight of component A2;
from 1 to 4.5 parts by weight of component A3;
optionally from 0.1 to 5 parts by weight of component A4; and
from 20 to 70 parts by weight of component B, wherein component B comprises or consists of in particular toluene diisocyanate;
   from 5 to 35 parts by weight of component C,
   where the parts by weight of components A1 and C add up to 100 and the figures for the parts by weight of components A2, A3, A4 and B relate to the sum of components A1 and C.

In addition to the preferred polyether polyols, further hydroxyl group-containing compounds (polyols) can be used in the polyol formulation for producing flexible polyurethane foams. These polyols, which are known per se, are described in detail, for example by G. Oertel (Ed.): “Kunststoffhandbuch, Band 7, Polyurethane” [Plastics Handbook, volume 7, Polyurethanes], Hanser Verlag, Munich 1993, pp. 57-75.

Polyols used with preference are polyether polyols (particularly poly(oxyalkylene) polyols) and polyester polyols, the polyols used preferably having an OH number according to DIN 53240 in the range of 10 to 40, more preferably in the range from 15 to 35.

The polyether polyols are prepared by known methods, preferably by base-catalyzed polyaddition of alkylene oxides onto polyfunctional starter compounds having active hydrogen atoms, such as for example alcohols or amines Examples include: ethylene glycol, diethylene glycol, 1,2-propylene glycol, 1,4-butanediol, hexamethylene glycol, bisphenol A, trimethylolpropane, glycerol, pentaerythritol, sorbitol, sucrose, degraded starch, water, methylamine, ethylamine, propylamine, butylamine, aniline, benzylamine, o- and p-toluidine, α,β-naphthylamine, ammonia, ethylenediamine, propylenediamine, 1,4-butylenediamine, 1,2-, 1,3-, 1,4-, 1,5- and/or 1,6-hexamethylenediamine, o-, m-, and p-phenylenediamine, 2,4-, 2,6-toluenediamine, 2,2′-, 2,4- and 4,4′-diaminodiphenylmethane and diethylenediamine. The filled polyol of component A1 preferably has an OH number in accordance with DIN 53240 in the range of 10 to 40, preferably in the range of 15 to 35, more preferably in the range of 20 to 30.

The alkylene oxides used are preferably ethylene oxide, propylene oxide, butylene oxide and also mixtures thereof. The construction of the polyether chains by alkoxylation may be performed with only one monomeric epoxide or else in random or blockwise fashion with two or three different monomeric epoxides.

Processes for producing such polyether polyols are described in “Kunststoffhandbuch, Band 7, Polyurethane” [Plastics Handbook, volume 7, Polyurethanes], in “Reaction Polymers”.

The addition of alkylene oxides onto the starter compounds can also be effected with DMC catalysis, for example.

In addition to these “simple” polyether polyols, the process according to the invention may also employ polyether carbonate polyols. Polyether carbonate polyols may be obtained, for example, by catalytic reaction of ethylene oxide and propylene oxide, optionally further alkylene oxides, and carbon dioxide in the presence of H-functional starter substances (see for example EPA 2046861).

Processes for producing polyester polyols are likewise well known and described for example in the two citations mentioned above (“Kunststoffhandbuch, Band 7, Polyurethane [Plastics Handbook, volume 7, Polyurethanes]”, “Reaction Polymers”). The polyester polyols are produced inter alia by polycondensation of polyfunctional carboxylic acids or derivatives thereof, for example acid chlorides or anhydrides, with polyfunctional hydroxyl compounds.

Examples of polyfunctional carboxylic acids that can be used include: adipic acid, phthalic acid, isophthalic acid, terephthalic acid, oxalic acid, succinic acid, glutaric acid, azelaic acid, sebacic acid, fumaric acid or maleic acid.

Examples of the polyfunctional hydroxyl compounds that can be used include: ethylene glycol, diethylene glycol, triethylene glycol, 1,2-propylene glycol, dipropylene glycol, 1,3-butanediol, 1,4-butanediol, 1,6-hexanediol, 1,12-dodecanediol, neopentyl glycol, trimethylolpropane, triethylolpropane or glycerol.

The polyester polyols may in addition also be prepared by ring-opening polymerization of lactones (e.g. caprolactone) with diols and/or triols as starters.

The polyether polyols, polyether carbonate polyols and polyester polyols described above can also be used concomitantly with filler-containing polyols such as polymer polyols (comprising styrene-acrylonitrile copolymers in dispersed form, so-called SAN-modified polyols) or polyurea dispersion polyols etc. for producing the flexible polyurethane foams. SAN-modified polyols are preferably used, particularly preferably those having a solids content of 20 to 50% by weight, particularly 35 to 45% by weight, based on the modified polyol. Filled polyol preferably has an OH number in accordance with DIN 53240 in the range of 10 to 40, preferably in the range of 15 to 35, more preferably in the range of 20 to 30.

In addition, in the production of the polyurethanes according to the invention, a crosslinker component can be added. Such crosslinkers that may be used are, e.g. diethanolamine, triethanolamine, glycerol, trimethylolpropane (TMP), adducts of such crosslinker compounds with ethylene oxide and/or propylene oxide having an OH number <1000 or also glycols having a number-average molecular weight ≤1000. Preference is given to triethanolamine, glycerol, TMP or low EO- and/or PO adducts thereof. Particular preference is given to diethanolamine.

In addition, known auxiliaries, additives and/or flame retardants can optionally be added. Auxiliaries are particularly understood here to mean catalysts and stabilizers known per se. As flame retardants, it is possible to use, e.g. melamine or TCPP.

Preferably employed catalysts include: aliphatic tertiary amines (for example triethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethylbisaminoethyl ether), cycloaliphatic amino ethers (for example N-ethylmorpholine), aliphatic amidines, cycloaliphatic amidines, urea, and derivatives of urea (for example aminoalkylureas; see, for example, EP-A 0 176 013, especially (3-dimethylaminopropylamino)urea). Non-emissive or emissive catalysts may also be used. Particularly preferably used areemissive catalysts comprising bis(2-dimethylaminoethyl) ether, for example sold under the trade name Niax Catalyst A-400, and/or 1,4-diaza(2,2,2)bicyclooctane, for example sold under the trade name DABCO 33-LV.

It is also possible to use tin (II) salts of carboxylic acids as catalysts, with the parent carboxylic acid in each case preferably having from 2 to 20 carbon atoms. Particular preference is given to the tin (II) salt of 2-ethylhexanoic acid (i.e. tin (II) 2-ethylhexanoate), the tin (II) salt of 2-butyloctanoic acid, the tin (II) salt of 2-hexyldecanoic acid, the tin (II) salt of neodecanoic acid, the tin (II) salt of oleic acid, the tin (II) salt of ricinoleic acid and tin (II) laurate. It is also possible to employ tin (IV) compounds as catalysts, for example dibutyltin oxide, dibutyltin dichloride, dibutyltin diacetate, dibutyltin dilaurate, dibutyltin maleate or dioctyltin diacetate. It is of course also possible to use all the catalysts mentioned as mixtures.

Further representatives of the catalysts to be used and details of the mode of action of the catalysts are described in Vieweg and Höchtlen (Eds.): Kunststoff-Handbuch, Volume VII, Carl-Hanser Verlag, Munich 1966, pp. 96-102.

The catalysts are preferably used in amounts of about 0.001% to 10% by weight, based on the total amount of compounds having at least two hydrogen atoms reactive toward isocyanates.

Further additives that may optionally be used are surface-active additives such as emulsifiers and foam stabilizers. Suitable emulsifiers are for example the sodium salts of castor oil sulfonates or salts of fatty acids with amines such as diethylamine oleate or diethanolamine stearate. Alkali metal or ammonium salts of sulfonic acids such as for instance of dodecylbenzenesulfonic acid or dinaphthylmethanedisulfonic acid or of fatty acids such as ricinoleic acid or of polymeric fatty acids can also be used as surface-active additives.

Foam stabilizers used are particularly polyethersiloxanes, especially water-soluble representatives. The construction of these compounds is generally such that a copolymer of ethylene oxide and propylene oxide is attached to a polydimethylsiloxane radical. Of particular interest are polysiloxane-polyoxyalkylene copolymers multiply branched via allophanate groups according to DE-A 25 58 523.

Further potential additives are reaction retardants, for example acidic substances such as hydrochloric acid or organic acid halides, also cell regulators known per se such as paraffins or fatty alcohols or dimethylpolysiloxanes and pigments or dyes known per se and flame retardants, e.g. tris(2-chloroisopropyl) phosphate, tricresyl phosphate or ammonium phosphate and ammonium polyphosphate, also stabilizers for aging and weathering effects, plasticizers and fungistatic and bacteriostatic substances as well as fillers such as barium sulfate, kieselguhr, carbon black or precipitated chalk.

Further examples of surface-active additives and foam stabilizers and cell regulators, reaction retarders, stabilizers, flame retardants, plasticizers, dyes and fillers and fungistatic and bacteriostatic substances for optional concomitant use according to the invention and details concerning use and mode of action of these additives are described in Vieweg and Höchtlen (Eds.): Kunststoff-Handbuch, Volume VII, Carl-Hanser Verlag, Munich 1966, pp. 103-113.

To be used as blowing agent component are all usable blowing agents known in polyurethane foam production. Organic blowing agents include, e.g. acetone, ethyl acetate, alkanes, halogen-substituted alkanes such as methylene chloride, while inorganic blowing agents include e.g. air or CO₂. A blowing effect can also be achieved by addition of compounds which decompose with elimination of gases, for example of nitrogen, at temperatures above room temperature, for example azo compounds such as azodicarbonamide or azoisobutyronitrile. Particular preference is given to using water as chemical blowing agent. Further examples of blowing agents and details concerning use of blowing agents are described in Vieweg and Höchtlen (Eds.): Kunststoff-Handbuch, Volume VII, Carl-Hanser Verlag, Munich 1966, p. 108f, p. 453ff and p. 507ff. However, the sole blowing agent is preferably water or CO₂.

Component B preferably comprises the readily industrially accessible polyisocyanates, for example toluene 2,4- and 2,6-diisocyanate and any desired mixtures of these isomers (“TDI”); or polyphenyl polymethylene polyisocyanates as prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially those modified polyisocyanates which derive from toluene 2,4- and/or 2,6-diisocyanate or from diphenylmethane 4,4′- and/or 2,4′-diisocyanate. Component B preferably comprises or consists of 2,4- and/or 2,6-toluene diisocyanate or mixtures thereof.

Carrying Out the Process for Producing Polyurethane Foams

The production of isocyanate-based foams is known per se and described for example in DE-A 1 694 142, DE-A 1 694 215 and DE-A 1 720 768 and also in Kunststoff-Handbuch [Plastics Handbook] volume VII, Polyurethane [Polyurethanes], edited by Vieweg and Höchtlen, Carl Hanser Verlag, Munich 1966, and in the new edition of this book, edited by G. Oertel, Carl Hanser Verlag Munich, Vienna 1993.

To carry out the process according to the invention, the reaction components are reacted by the one-step process known per se or by the prepolymer process or the semi-prepolymer process, often preferably using mechanical means, for example those described in U.S. Pat. No. 2,764,565.

The foams according to the invention are molded foams. The production of the foams is conducted in closed molds. In this case, the reaction mixture is introduced into a mold. Mold materials include metal, e.g. aluminum, steel or plastic, for example epoxide resin. In the mold, the foamable reaction mixture is foamed and forms the molded article. The mold foaming can be carried out in this case such that the molded article has cell structure on its surface. It can also be carried out such that the molded article has a compact skin and a cellular core. In accordance with the invention, it can be provided in this context that as much foamable reaction mixture is introduced into the mold that the foam formed just fills the mold. However, it can also be operated such that more foamable reaction mixture is introduced into the mold than is required to fill the mold interior with foam. In the latter-mentioned case, therefore, so-called overpacking is employed; a procedure of this type is known, for example, from U.S. Pat. Nos. 3,178,490 and 3,182,104.

During the mold foaming, “external release agents” known per se such as silicone oils are frequently used. However, so-called “internal release agents” can also be used, optionally in a mixture with external release agents, which are apparent, for example, from DE-OS 21 21 670 and DE-OS 23 07 589.

The flexible polyurethane foam according to the invention preferably emits aliphatic amines when measured according to the VDA 278 test from 2011, heating for the determination of VOC, of ≤10 mg/kg, preferably ≤5 mg/kg, more preferably ≤1 mg/kg. In a preferred embodiment, the flexible polyurethane foam has a humid aged compression set, 50%/22 h/70° C., in accordance with DIN EN ISO 1856-2008, of 5 to 25%, preferably of 0 to 10%. Furthermore, the flexible polyurethane foam according to the invention has a humid aged load loss according to DIN EN ISO 3386-1 from 10/2015 of −10 to 20%. In a further preferred embodiment, the flexible polyurethane foam has a humid aged compression set according to DIN EN 1856 from 2008, after steam autoclaving for 3 hours at 105° C., of 0 to 40%.

In a first embodiment, the invention relates to a process for producing an amine-based polyol for the production of flexible polyurethane foam, comprising the following steps:
a) reacting an amine of the general formula (I)

R¹₂N—(CH₂)ₙ—NH₂ (I)
where R¹ is in each case a different or the same C₁ to C₁₀ alkyl radical and n is an integer from 1 to 10,
with an epoxide A,
wherein the epoxide A and the amine are used in a molar ratio from 10:1 to 50:1, and
the reaction is conducted until at least 90% by weight of the epoxide A used has reacted, so that an intermediate is obtained,
b) reacting the intermediate with an epoxide B, which is different from epoxide A,
   wherein epoxide B is used in an amount which corresponds to a molar ratio of the epoxide to the amine from 8:1 to 40:1, and
   the reaction is conducted until at least 90% by weight of the epoxide B used has reacted, so that the amine-based polyol is obtained.

In a second embodiment, the invention relates to a process according to embodiment 1, characterized in that, in the amine of the general formula (I), R¹ is in each case the same C₁ to C₃ alkyl radical and n is an integer from 2 to 6, where R¹ is preferably in each case a methyl radical.

In a third embodiment, the invention relates to a process according to either of embodiments 1 or 2, characterized in that the amine of the general formula (I) is 3-dimethylamino-1-propylamine.

In a fourth embodiment, the invention relates to a process according to any of the preceding embodiments, characterized in that the epoxide A is propylene oxide and/or the epoxide B is ethylene oxide.

In a fifth embodiment, the invention relates to a process according to any of the preceding embodiments, characterized in that the reaction in steps a) and/or b) is carried out in the presence of a catalyst and/or in steps a) and/or b) and/or after completion of step b) an antioxidant is used.

In a sixth embodiment, the invention relates to a process according to any of the preceding embodiments, characterized in that the reaction in step a) is conducted until at least 95% by weight, preferably at least 98% by weight, of the epoxide A used has reacted and/or the reaction in step b) is conducted until at least 95% by weight, preferably at least 98% by weight, of the epoxide B used has reacted.

In a seventh embodiment, the invention relates to an amine-based polyol obtained by or obtainable by a process according to any of embodiments 1 to 6.

In an eighth embodiment, the invention relates to the use of the amine-based polyol according to embodiment 7 as non-emissive catalyst in the production of flexible polyurethane foam, particularly in the production in a cold-cure foam process.

In a ninth embodiment, the invention relates to the use according to embodiment 8, characterized in that furniture upholstery, textile inserts, mattresses, automobile seats, headrests, armrests, sponges, roof linings, door side panels, seat covers or structural elements are produced.

In a tenth embodiment, the invention relates to a flexible polyurethane foam obtained or obtainable by reacting a composition comprising or consisting of
an isocyanate-reactive component A1 comprising or consisting of compounds having isocyanate-reactive hydrogen atoms and/or a filled polyol;
a further isocyanate-reactive component A2, different from A1;
a component A3 comprising or consisting of at least one blowing agent;
optionally a component A4 comprising or consisting of auxiliaries and additives; and
a component B comprising or consisting of at least one aromatic polyisocyanate; preferably toluene diisocyanate;
a component C comprising or consisting of an amine-based polyol obtained or obtainable by a process according to embodiments 1 to 6,

wherein the reaction is carried out at an isocyanate index of 70 to 120.

In an eleventh embodiment, the invention relates to a flexible polyurethane foam according to embodiment 10, characterized in that the composition comprises or consists of
from 65 to 95 parts by weight of component A1; wherein component A1 preferably comprises 5 to 60 parts by weight, based on the mass of component A1 and A2, of a filled polyol,
from 0.1 to 5 parts by weight of component A2;
from 1 to 4.5 parts by weight of component A3;
optionally from 0.1 to 5 parts by weight of component A4; and
from 20 to 70 parts by weight of component B, wherein component B comprises or consists of in particular toluene diisocyanate
   from 5 to 35 parts by weight of component C

where the parts by weight of components A1 and C add up to 100 and the figures for the parts by weight of components A2, A3, A4 and B relate to the sum of components A1 and C.

In a twelfth embodiment, the invention relates to a flexible polyurethane foam according to either of embodiments 10 or 11, characterized in that the flexible polyurethane foam emits aliphatic amines when measured according to the VDA 278 test from 2011, heating for the determination of VOC, of ≤10 mg/kg, preferably ≤5 mg/kg, more preferably ≤1 mg/kg.

In a thirteenth embodiment, the invention relates to a flexible polyurethane foam according to any of embodiments 10 to 12, characterized in that the flexible polyurethane foam has a humid aged compression set, 50%/22 h/70° C., in accordance with DIN EN ISO 1856-2008, of 5 to 25%, preferably from 0 to 10%.

In a fourteenth embodiment, the invention relates to a flexible polyurethane foam according to any of embodiments 10 to 13, characterized in that the flexible polyurethane foam has a humid aged load loss according to DIN EN ISO 3386-1 from 10/2015 of −10 to 20%.

In a fifteenth embodiment, the invention relates to a flexible polyurethane foam according to any of embodiments 10 to 14, characterized in that the flexible polyurethane foam has a humid aged compression set according to DIN EN 1856 from 2008, after steam autoclaving for 3 hours at 105° C., of 0 to 40%.

### EXAMPLES

The present invention is elucidated further by the examples which follow, but without being restricted thereto.

Production of Amine-Initiated Polyols

Firstly, amine-initiated polyols were produced. The following starting materials were used

| | |
|---|---|
| Amine I | 3-dimethylamino-1-propylamine |
| Amine II | ethylenediamine-initiated polyether based on |
| | propylene oxide having an OH number of 470 |
| | mg KOH/g commercially produced by Covestro |
| | Deutschland AG. The content of |
| | ethylenediamine in this polyether is 12.59% |
| | by weight and the content of propylene oxide |
| | corresponds to 87.41% by weight. |
| Amine III | N-methyldiethanolamine |
| Propylene oxide | |
| Ethylene oxide | |
| IRGANOX ® 1076 | octadecyl 3-(3,5-di-tert-butyl-4- |
| | hydroxyphenyl)propionate |

Amine I (3-Dimethylamino-1-Propylamine)-Initiated Precursor:

A 2 L laboratory autoclave was charged with 583.6 g of 3-dimethylamino-1-propylamine under a nitrogen atmosphere. Oxygen was removed at room temperature by 4-fold pressurization of the autoclave with nitrogen to an absolute pressure of 3 bar and subsequent release of the positive pressure to standard pressure. After the autoclave had been closed, its contents were then heated to 105° C. with stirring (800 rev/min, cross-bar stirrer). A pressure of 1.9 bar was established. After the reaction temperature of 105° C. had been reached, metered addition of 663.6 g of propylene oxide into the head space of the autoclave was started. The maximum pressure reached during the metered addition time of 5 hours was 4 bar. After completion of the propylene oxide metered addition, a post-reaction time of 3.0 hours followed. The product was then heated at 105° C. under reduced pressure (34 mbar) over a period of 40 minutes. After cooling to room temperature, 0.642 g of IRGANOX® 1076 were added. The OH number was 482 mg KOH/g. The precursor comprises 53.21% by weight oxypropylene units, based on the total mass of the precursor.

Production of the Amine-Initiated Polyols

Amine-Initiated Polyol No. 1 According to the Invention:

A 10 L laboratory autoclave was charged with 451.8 g of the amine I-started precursor and 62.4 g of a 44.81% aqueous KOH solution under a nitrogen atmosphere. The mixture obtained was heated to 110° C. with stirring at 200 rev/min (grid stirrer) and dewatered over a period of 3 hours at this temperature and stirrer speed under reduced pressure at 90 mbar. The stirrer speed was then increased to 450 rev/min and 5240.1 g of propylene oxide were metered into the autoclave over a period of 4.67 hours. The end of metered addition of propylene oxide was followed by a post-reaction phase of duration 4 h. Then, also at 110° C. reaction temperature and 450 rev/min, 1310.3 g of ethylene oxide were added to the reactor over a period of 2.65 hours. The subsequent post-reaction lasted 2 hours. The reactor contents were finally heated at 110° C. under reduced pressure (120 mbar) over a period of 1.3 hours. After cooling to 80° C., first 700 ml of distilled water and then 220.1 g of an 11.713% by weight aqueous sulfuric acid solution were added and the mixture was stirred for 0.5 hours. Finally, 2.677 g of IRGANOX® 1076 were added and the mixture was stirred at 80° C. for a further 30 minutes.

The mixture thus obtained was transferred to a glass flask under a nitrogen blanket and initially dewatered therein at 80° C. under reduced pressure using a water pump and finally heated for a further 3 hours at 110° C. under a pressure of 20 mbar (membrane pump). The resulting salt was filtered off through a depth filter (T 750) in a heatable pressure suction filter. The OH number was 27.2 mg KOH/g.

The post-reaction after the end of the metered addition of an epoxide block was always considered to have ended when the rate of pressure decrease in the reaction autoclave fell below the value of 20 mbar/h.

### Reference Example of Amine-Initiated Polyol No. 2

A 2 L laboratory autoclave was charged with 96.2 g of the amine I-initiated precursor and 13.5 g of a 44.89% aqueous KOH solution under a nitrogen atmosphere. The mixture obtained was heated to 110° C. with stirring at 200 rev/min (cross-bar stirrer) and dewatered over a period of 3 hours at this temperature and stirrer speed under reduced pressure at 90 mbar. The stirrer speed was then increased to 800 rev/min and 281 g of ethylene oxide were metered into the autoclave over a period of 2.8 hours. The end of metered addition of ethylene oxide was followed by a post-reaction phase of duration 1.8 hours. Then, after lowering the reaction temperature to 105° C. and also at a stirrer speed of 800 rev/min, 1123.4 g of propylene oxide were added to the reactor over a period of 6.9 hours. The subsequent post-reaction lasted 5 hours. The reactor contents were finally heated at 105° C. under reduced pressure (80 mbar) over a period of 1 hour. After cooling to 80° C., first 150 ml of distilled water and then 46.588 g of a 12.25% by weight aqueous sulfuric acid solution were added and the mixture was stirred for 0.5 hours. Finally, 0.626 g of IRGANOX® 1076 were added and the mixture was stirred at 80° C. for a further 30 minutes.

The mixture thus obtained was transferred to a glass flask under a nitrogen blanket and initially dewatered therein at 80° C. under reduced pressure using a water pump and finally heated for a further 3 hours at 110° C. under a pressure of 20 mbar. The resulting salt was filtered off through a depth filter (T 750) in a heatable pressure suction filter. The OH number was 37.4 mg KOH/g.

### Reference Example of Amine-Initiated Polyol No. 3

A 2 L laboratory autoclave was charged with 94.4 g of the amine I-initiated precursor and 13.82 g of a 45.30% aqueous KOH solution under a nitrogen atmosphere. The mixture obtained was heated to 110° C. with stirring at 200 rev/min (cross-bar stirrer) and dewatered over a period of 3 hours at this temperature and stirrer speed under reduced pressure at 90 mbar. The stirrer speed was then increased to 800 rev/min, the reactor temperature was lowered to 105° C. and 1245.2 g of propylene oxide were metered into the autoclave over a period of 6.7 hours. The end of metered addition of propylene oxide was followed by a post-reaction phase of duration 6 h. Then, after increasing the reaction temperature to 110° C. and also at a stirrer speed of 800 rev/min, 140.4 g of ethylene oxide were added to the reactor over a period of 1.5 hours. The subsequent post-reaction lasted 1 hour. The reactor contents were finally heated at 110° C. under reduced pressure (80 mbar) over a period of 0.5 hours. After cooling to 80° C., first 150 ml of distilled water and then 47.02 g of a 12.25% by weight aqueous sulfuric acid solution were added and the mixture was stirred for 0.5 hours. Finally, 0.616 g of IRGANOX® 1076 were added and the mixture was stirred at 80° C. for a further 30 minutes.

The mixture thus obtained was transferred to a glass flask under a nitrogen blanket and initially dewatered therein at 80° C. under reduced pressure using a water pump and finally heated for a further 3 hours at 110° C. under a pressure of 20 mbar. The resulting salt was filtered off through a depth filter (T 750) in a heatable pressure suction filter. The OH number was 40.4 mg KOH/g.

### Reference Example of Amine-Initiated Polyol No. 4

A 2 L laboratory autoclave was charged with 121.1 g of the amine II (ethylenediamine-initiated polyether having an OHN of 470 mg KOH/g) and 14.57 g of a 44.89% aqueous KOH solution under a nitrogen atmosphere. The mixture obtained was heated to 110° C. with stirring at 200 rev/min (cross-bar stirrer) and dewatered over a period of 3.2 hours at this temperature and stirrer speed under reduced pressure at 80 mbar. The stirrer speed was then increased to 800 rev/min and 1211.6 g of propylene oxide were metered into the autoclave over a period of 5.8 hours. The end of metered addition of propylene oxide was followed by a post-reaction phase of duration 6 h. Then, again at a stirrer speed of 800 rev/min, 302.9 g of ethylene oxide were added to the reactor over a period of 1.5 hours. The subsequent post-reaction lasted 1 hour. The reactor contents were finally heated at 110° C. under reduced pressure (80 mbar) over a period of 0.9 hours. After cooling to 80° C., first 150 ml of distilled water and then 48.62 g of a 12.25% by weight aqueous sulfuric acid solution were added and the mixture was stirred for 0.5 hours. Finally, 0.616 g of IRGANOX® 1076 were added and the mixture was stirred at 80° C. for a further 30 minutes.

The mixture thus obtained was transferred to a glass flask under a nitrogen blanket and initially dewatered therein at 80° C. under reduced pressure using a water pump and finally heated for a further 3 hours at 110° C. under a pressure of 20 mbar. The resulting salt was filtered off through a depth filter (T 750) in a heatable pressure suction filter. The OH number was 32.1 mg KOH/g.

### Reference Example of Amine-Initiated Polyol No. 5

A 2 L laboratory autoclave was charged with 49.5 g of amine III and 13.44 g of a 44.89% aqueous KOH solution under a nitrogen atmosphere. The mixture obtained was heated to 110° C. with stirring at 200 rev/min (cross-bar stirrer) and dewatered over a period of 3 hours at this temperature and stirrer speed under reduced pressure at 70 mbar. The stirrer speed was then increased to 800 rev/min and 1169.9 g of propylene oxide were metered into the autoclave over a period of 5.5 hours. The end of metered addition of propylene oxide was followed by a post-reaction phase of duration 7 h. Then, again at a stirrer speed of 800 rev/min, 280.9 g of ethylene oxide were added to the reactor over a period of 1.6 hours. The subsequent post-reaction lasted 1.3 hours. The reactor contents were finally heated at 110° C. under reduced pressure (80 mbar) over a period of 0.5 hours. After cooling to 80° C., first 150 ml of distilled water and then 48.70 g of a 12.25% by weight aqueous sulfuric acid solution were added and the mixture was stirred for 0.5 hours. Finally, 0.779 g of IRGANOX® 1076 were added and the mixture was stirred at 80° C. for a further 30 minutes.

The mixture thus obtained was transferred to a glass flask under a nitrogen blanket and initially dewatered therein at 80° C. under reduced pressure using a water pump and finally heated for a further 3 hours at 110° C. under a pressure of 20 mbar. The resulting salt was filtered off through a depth filter (T 750) in a heatable pressure suction filter. The OH number was 33.7 mg KOH/g.

Amine-Initiated Polyol No. 6 According to the Invention:

A 2 L laboratory autoclave was charged with 98.5 g of the amine I-initiated precursor and 13.377 g of a 44.81% aqueous KOH solution under a nitrogen atmosphere. The mixture obtained was heated to 110° C. with stirring at 200 rev/min (cross-bar stirrer) and dewatered over a period of 3 hours at this temperature and stirrer speed under reduced pressure at 90 mbar. The stirrer speed was then increased to 800 rev/min and 838.5 g of propylene oxide were metered into the autoclave over a period of 4.25 hours. The end of metered addition of propylene oxide was followed by a post-reaction phase of duration 8 h. Then, also at 110° C. reaction temperature and 4800 rev/min, 558.9 g of ethylene oxide were added to the reactor over a period of 3.68 hours. The subsequent post-reaction lasted 1 hour. The reactor contents were finally heated at 110° C. under reduced pressure (70 mbar) over a period of 1.5 hours. After cooling to 80° C., first 150 ml of distilled water and then 48.223 g of a 11.53% by weight aqueous sulfuric acid solution were added and the mixture was stirred for 0.5 hours. Finally, 0.615 g of IRGANOX® 1076 were added and the mixture was stirred at 80° C. for a further 30 minutes.

The mixture thus obtained was transferred to a glass flask under a nitrogen blanket and initially dewatered therein at 80° C. under reduced pressure using a water pump and finally heated for a further 3 hours at 110° C. under a pressure of 20 mbar (membrane pump). The resulting salt was filtered off through a depth filter (T 750) in a heatable pressure suction filter. The OH number was 28.3 mg KOH/g.

The properties of the respective amine-based polyols are summarized in Table 1:

TABLE 1
Composition and properties of the amine-based polyols

| | According | | | | | According |
|---|---|---|---|---|---|---|
| | to the | | | | | to the |
| | invention | Reference | | | | invention |
| Amine-based polyol No. | 1 | 2 | 3 | 4 | 5 | 6 |
| OH number [mg KOH/g] | 27.2 | 37.4 | 40.4 | 32.1 | 33.7 | 28.3 |
| Molar ratio of propylene | 45.6:1 | 46.0:1 | 51.9:1 | 89.3:1 | 30.5:1 | 33.8:1 |
| oxide to amine | | | | | | |
| Molar ratio of ethylene | 14.4:1 | 14.5:1 | 7.4:1 | 27.1:1 | 9.7:1 | 26.8:1 |
| oxide to amine | | | | | | |
| End block mainly due to | yes | no | yes | yes | yes | yes |
| ethylene oxide | | | | | | |
| Water content [ppm] | 1100 | 1300 | 800 | 700 | 1500 | 600 |
| Viscosity at 25° C. [mPas] | 444 | 253 | 372 | 755 | 677 | n.d. |

The amine-based polyols 1, 2, 3, 5 and 6 had an OH number, calculated on the basis of the ratios of the feedstocks, of 33 mg KOH/g. The amine-based polyol 4 had an OH number, calculated on the basis of the ratios of the feedstocks, of 35 mg KOH/g.

The (measured) OH numbers given in Table 1 were determined in accordance with ASTM D 4274-05. The measured OH numbers, however, only provide an indication of how many hydroxyl groups are present in the amine-based polyols, since the measurement result can be falsified by the amine group of the amine-based polyol.

The percentages by weight of ethylene oxide and propylene oxide, based in each case on the total mass of the epoxides metered, in the polyether chains of the amine-based polyols synthesized are summarized in Table 2:

TABLE 2
Percentages by weight of ethylene oxide and propylene oxide

| | Amine- | % By weight of the respective epoxides in the |
|---|---|---|
| | initiated | polyether chains, based in each case on the |
| | polyol No. | mass of the epoxides metered |
| According to | 1 | Amine I - PO [80.7] - EO [19.3] |
| the invention | | |
| Reference | 2 | Amine I - PO [3.5] - EO [19.3] -PO [77.2] |
| Reference | 3 | Amine I - PO [90.2] - EO [9.8] |
| Reference | 4 | Amine II - PO [81.3] - EO [18.7] |
| Reference | 5 | Amine III - PO [80.6] - EO [19.4] |
| According to | 6 | Amine I - PO [60] - EO [40] |
| the invention | | |

PO = propylene oxide;
EO = ethylene oxide

Production of MDI-Based Flexible Polyurethane Foam

Flexible polyurethane foams were produced with the following components. The composition of the flexible polyurethane foams is shown in Table 3.

| | |
|---|---|
| Polyether | Arcol ® Polyol 1374; Reactive polyether triol; |
| polyol | OH number 27 mg KOH/g |
| Amine-based | 1-6 as described above |
| polyols | |
| Additive 1 | Tegostab B 8715LF2 (OH number 82 mg KOH/g) |
| Niax | Catalyst A-400 emissive catalyst comprising |
| | bis(2-dimethylaminoethyl) ether; Momentive product |
| DABCO 33-LV | 1,4-Diazabicyclo[2.2.2]octane (33%) in |
| | dipropylene glycol; Evonik product |
| Cell opener | Desmophen 41WB01; reactive polyether, a triol |
| | having a high proportion of oxyethylene units; |
| | commercial product from Covestro; OH |
| | number 37 mg KOH/g |
| Isocyanate | mixture of diphenylmethane-4,4′-diisocyanate |
| | with isomers and homologues with higher functionality |
| | (MDI), NCO content 32.57% (Desmodur VP.PU |
| | PU 3230; product from Covestro) |

The components listed in the examples in Table 3 below are mixed with one another to give a reaction mixture in the one-stage process in the manner of processing customary for the production of flexible molded polyurethane foams in the cold-cure foam process. The reaction mixture is introduced into a metal mold that has been heated to 60° C. and coated previously with a release agent (PURA E1429H NV (Chem-Trend)). The amount used is selected according to the desired bulk density and the mold volume. It was made with a mold having a volume of 9.7 dm³. The moldings were demolded and wrung-out after 4 minutes. After 4 hours the moldings were sealed in aluminum composite film. When calculating the index given in Table 3, the OH number experimentally determined according to ASTM D 4274-05 was used for each of the amine-based polyols.

TABLE 3
Composition and properties of MDI-based flexible polyurethane foams

| | According | | | | | According | |
|---|---|---|---|---|---|---|---|
| | to the | | | | | to the | |
| HR foam | invention | Reference | | | | invention | Reference |
| [parts by weight] | 1 | 2 | 3 | 4 | 5 | 6 | 6A |
| Polyether polyol | 68.00 | 68.00 | 68.00 | 68.00 | 68.00 | 68.00 | 98.00 |
| Amine-based polyol 1 | 30.00 | — | — | — | — | — | — |
| Amine-based polyol 2 | — | 30.00 | — | — | — | — | — |
| Amine-based polyol 3 | — | — | 30.00 | — | — | — | — |
| Amine-based polyol 4 | — | — | — | 30.00 | — | — | — |
| Amine-based polyol 5 | — | — | — | — | 30.00 | — | — |
| Amine-based polyol 6 | — | — | — | — | — | 30.00 | — |
| Water | 3.47 | 3.46 | 3.50 | 3.50 | 3.46 | 3.47 | 3.44 |
| Additive I | 1 | 1 | 1 | 1 | 1 | 1.0 | 1.00 |
| Cell opener | 2.00 | 2.00 | 2.00 | 2.00 | 2.00 | 2.0 | 2.00 |
| Niax A-400 | — | — | — | — | — | — | 0.20 |
| DABCO 33-LV | — | — | — | — | — | — | 0.30 |
| MDI | 60.50 | 61.68 | 61.68 | 61.68 | 61.42 | 56.17 | 56.93 |
| Index | 100 | 100 | 100 | 100 | 100 | 100 | 100 |
| Core density [kg/m³] | 55.7 | 57.2 | 55.6 | — | — | 54.9 | 55.1 |
| Compression hardness | 11.09 | 9.43 | 10.2 | — | — | 11.42 | 10.93 |
| CLD 4/40 [kPa] | | | | | | | |
| Tensile strength [kPa] | 188 | 168 | 187 | — | — | 163 | 185 |
| Elongation at break [%] | 130 | 128 | 132 | — | — | 99 | 130 |
| Emission values | 0 | 0 | 0 | — | — | 0 | 128 |
| Total aliphatic amines | | | | | | | |
| for VOC measurement | | | | | | | |
| according to VDA 278 | | | | | | | |
| [mg/kg] | | | | | | | |
| Humid aged | 8.1 | 28 | 9.1 | — | — | 9.5 | 5.1 |
| compression set | | | | | | | |
| CS 50%/22 h/70° C. [%] | | | | | | | |
| Humid aged | 54.1 | 71.2 | 23.2 | — | — | 17 | 7.4 |
| compression set | | | | | | | |
| CS 75%/22 h/70° C. [%] | | | | | | | |
| Humid aged | 22 | 25.1 | 20.4 | — | — | 20.4 | 15.0 |
| compression set | | | | | | | |
| CS 70%/22 h/40° C./95% | | | | | | | |
| humidity [%] | | | | | | | |
| Humid aged load loss | 19.75 | 20.25 | 19.22 | — | — | 17.16 | 11.16 |
| (CLD 4/40 [kPa]- | | | | | | | |
| Compression hardness | | | | | | | |
| after autoclaving CLD | | | | | | | |
| 4/40 | | | | | | | |
| [kPa])/Compression | | | | | | | |
| hardness | | | | | | | |
| CLD 4/40 [kPa]) | | | | | | | |
| HALL [%] | | | | | | | |
| Humid aged | 38.4 | 66.1 | 35.1 | — | — | 37.3 | 17.2 |
| compression set | | | | | | | |
| HACS [% ] | | | | | | | |
| Comment | — | — | | Collapse | Collapse | — | — |

Determination of the core density according to DIN EN ISO 845 from 10/2015 in the range of 25 to 90 kg/m³

Determination of the compression hardness according to DIN EN ISO 3386-1 from 10/2015 in the range of 2 to 12 kPa,

Determination of the tensile strength according to DIN EN ISO 1798 from 04/2008 in the range of 100 to 250 kPa

Determination of elongation at break according to DIN EN ISO 1798 from 04/2008 in the range of 100 to 250%

Determination of the humid aged compression set CS 50% according to DIN EN 1856 from 2008

Determination of the humid aged compression set CS 70% according to DIN EN 1856 from 2008

Determination of the humid aged compression set CS 75% according to DIN EN 1856 from 2008

Determination of the Humid Aged Load Loss (HALL) according to DIN EN ISO 3386-1 from 10/2015

Determination of the humid aged compression set, HACS 50%, in a steam autoclave for 3 hours at 105° C., according to DIN EN 1856 from 2008

The VDA 278 test (Association of the Automotive Industry; as of 2011) is a thermal desorption process for determining organic emissions from non-metallic materials at elevated temperatures. The samples are heated and the emitted substances are cryofocused with a stream of inert gas into a cold trap and then analyzed. In order to determine the proportion of volatile organic substances (VOC), the sample is heated to 90° C. When determining the VOC, volatile amines are also detected. The detection limit for VOC in the VDA 278 test is 1 mg/kg.

The experimental data impressively illustrate the advantages of the amine-initiated polyols according to the invention in the production of MDI-based flexible polyurethane foam with regard to emissions of volatile organic substances (VOC/FOG) from polyurethane foam. In Reference Example 6A, emissive catalysts were used in the synthesis of the polyurethane foam and this foam emitted 128 mg/kg of volatile constituents. In contrast to this, the emissions from the polyurethane foams with the non-emissive polyol according to the invention of Examples 1 and 6 according to the invention were below the limit of quantification of 1 mg/kg.

In addition, the experimental data show that the polyols according to the invention do not adversely affect the mechanical properties of the flexible polyurethane foams obtained. The flexible polyurethane foams according to the invention of Examples 1 and 6 have comparable values for the core density, the compression hardness, the tensile strength and the elongation at break as the polyurethane foam from Reference Example 6A, produced with conventional, emissive catalysts. The flexible polyurethane foams according to the invention of Examples 1 and 6 also had good humid aging properties. In the HALL test, the polyurethane foams according to the invention had values of less than 20% and in the HACS test of less than 40%.

Furthermore, reference examples 4 and 5 show that not every amine is suitable for the synthesis of a non-emissive polyol. The compositions which comprised these polyols not in accordance with the invention collapsed during the synthesis, so that no polyurethane foam could be obtained.

Determination of the Catalytic Properties of the Amine-Initiated Polyols in the Production of MDI-Based Flexible Polyurethane Foam

The catalytic activity of the amine-initiated, non-emissive polyols was determined by measuring the rise profile. For this purpose, the components listed in Table 4 were mixed and the expansion behavior of the foam sample was measured in a suitable vessel immediately after filling into the foam mold. The height of the rising foam is measured as a function of time. The sample should show a rapid increase and the height of the foam should then remain at the highest possible value, otherwise the foam sample will shrink.

TABLE 4
Composition of MDI-based flexible polyurethane foams for determining
the catalytic properties of amine-initiated polyols

| | According | | | | |
|---|---|---|---|---|---|
| | to the | | | | |
| HR foam | invention | Reference | | | |
| [Parts by weight] | 7 | 8 | 9 | 10 | 11 |
| Polyether polyol | 68.00 | 68.00 | 68.00 | 68.00 | 68.00 |
| Amine-based polyol 1 | 30.00 | — | — | — | — |
| Amine-based polyol 2 | — | 30.00 | — | — | — |
| Amine-based polyol 3 | — | — | 30.00 | — | — |
| Amine-based polyol 4 | — | — | — | 30.00 | — |
| Amine-based polyol 5 | — | — | — | — | 30.00 |
| Water | 3.47 | 3.46 | 3.50 | 3.50 | 3.45 |
| Crosslinker | 1.20 | 1.20 | 1.20 | 1.20 | 1.20 |
| Additive I | 1.00 | 1.00 | 1.00 | 1.00 | 1.00 |
| MDI | 60.50 | 61.68 | 61.68 | 61.68 | 61.42 |
| Index | 100 | 100 | 100 | 100 | 100 |

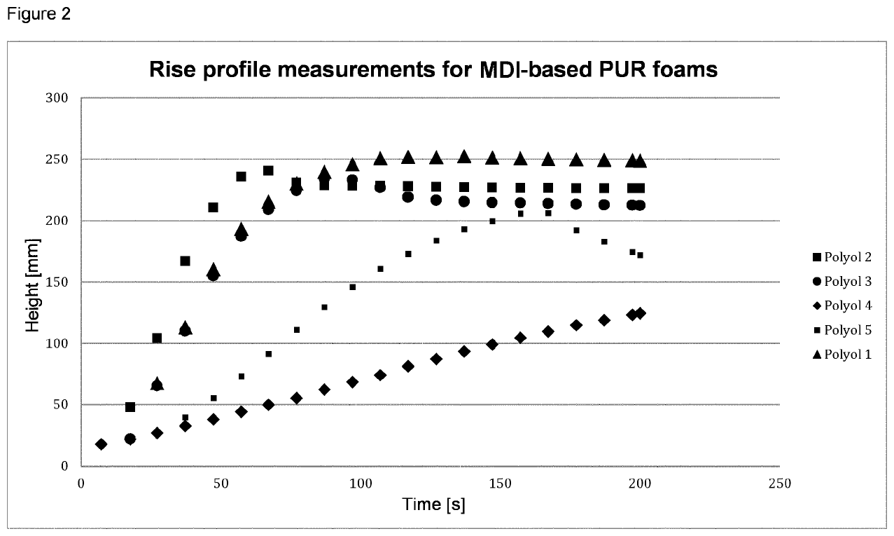

The results of the measurements are shown in FIG. 2.

The experimental data show that the amine-initiated polyol 1 according to the invention has an advantageous catalytic effect in the production of MDI-based flexible polyurethane foams. The MDI-based flexible polyurethane foam 7, produced with the amine-initiated polyols 1 according to the invention, reached foam heights of more than 200 mm within a short period of time. Of the MDI-based flexible polyurethane foams, foam 7 with the amine-initiated polyol 1 according to the invention foamed to the overall highest maximum foam height of 250 mm within ca. 100 s.

Compared to amine-initiated polyols according to the invention, it was not possible to obtain any MDI-based flexible polyurethane foams with the polyols not in accordance with the invention of reference Examples 10 and 11. In reference example 10, the composition for producing a flexible polyurethane foam only reached a maximum height of ca. 125 mm, and in reference Example 11 the composition collapsed after reaching the maximum foam height.

Production of TDI-Based Flexible Polyurethane Foam

Flexible polyurethane foams were produced with the following components. The composition of the flexible polyurethane foams is shown in Table 5.

| | |
|---|---|
| Polyether polyol | Polyether polyol having an OH number of 31.5 |
| | mg KOH/g, produced in the presence of KOH as |
| | catalyst by adding propylene oxide and |
| | ethylene oxide in a ratio of 82.5 to 17.5 |
| | using glycerol and sorbitol in a ratio of |
| | 70.8 to 29.2 as starter having 85 mol % of |
| | primary OH groups |
| SAN-modified | Hyperlite 1650; reactive polyol, modified |
| polyol | with styrene-acrylonitrile (SAN) having a |
| | solids content of ca. 43% by weight; OH |
| | number 20.2 mg KOH/g; product of |
| | Covestro Deutschland AG |
| amine-initiated | 1-5 as described above |
| polyols | |
| Additive II | Tegostab B 8736LF2, silicone-based wetting |
| | agent for the foam mold (OH number 72 mg |
| | KOH/g), product of Evonik |
| Additive III | Tegostab B 8734LF2 (OH number 83 mg KOH/g), |
| | product of Evonik |
| Crosslinker | Diethanolamine, OH number 1609 mg KOH/g |
| Catalyst | Emissive catalyst (Niax Catalyst A-400) |
| | comprising bis(2-dimethylaminoethyl) ether; |
| | product of Momentive |
| DABCO 33-LV | 1,4-Diazabicyclo[2.2.2]octane (33%) in |
| | dipropylene glycol; Evonik product |
| Isocyanate | Toluene diisocyanate (TDI) NCO content 48.3% |

The TDI-based flexible polyurethane foams were produced by the process described above for MDI-based flexible polyurethane foams, the molded parts being removed from the mold after 5 minutes. When calculating the index given in Table 5, the OH number experimentally determined according to ASTM D 4274-05 was used for each of the amine-based polyols.

TABLE 5
Composition and properties of TDI-based flexible polyurethane foams

| | According | | | | | |
|---|---|---|---|---|---|---|
| | to the | | | | | |
| HR foam | invention | Reference | | | | |
| [Parts by weight] | 12 | 13 | 14 | 15 | 16 | 17 |
| Polyether polyol | 45.00 | 45.00 | 45.00 | 45.00 | 45.00 | 75.00 |
| SAN-modified polyol | 25.00 | 25.00 | 25.00 | 25.00 | 25.00 | 25.00 |
| Amine-based polyol 1 | 30.00 | — | — | — | — | — |
| Amine-based polyol 2 | — | 30.00 | — | — | — | — |
| Amine-based polyol 3 | — | — | 30.00 | — | — | — |
| Amine-based polyol 4 | — | — | — | 30.00 | — | — |
| Amine-based polyol 5 | — | — | — | — | 30.00 | — |
| Water | 2.77 | 2.76 | 2.80 | 2.80 | 2.75 | 2.72 |
| Crosslinker | 0.800 | 0.800 | 0.800 | 0.800 | 0.800 | 0.80 |
| Catalyst | | | | | | 0.25 |
| DABCO 33-LV | | | | | | 0.40 |
| Additive III | 0.60 | 0.60 | 0.60 | 0.60 | 0.60 | 0.60 |
| Isocyanate TDI | 34.67 | 35.11 | 35.63 | 35.63 | 35.32 | 35.58 |
| Index | 105 | 105 | 105 | 105 | 105 | 105 |
| Core density [kg/m³] | 50.1 | 48.7 | 48.2 | | | 47.3 |
| Compression hardness | 5.96 | 3.81 | 4.49 | | | 5.82 |
| CLD 4/40 [kPa] | | | | | | |
| Tensile strength [kPa] | 140 | 108 | 120 | | | 150 |
| Elongation at break [%] | 122 | 118 | 108 | | | 110 |
| Breaking strength [N/mm] | 0.418 | 0.228 | 0.266 | | | 0.295 |
| Emission values | 0 | 0 | 0 | | | 288 |
| Total aliphatic amines with | | | | | | |
| VOC measurement | | | | | | |
| according to VDA 278 | | | | | | |
| [mg/kg] | | | | | | |
| Compression hardness after | 5.13 | 3.56 | 4.65 | | | 5.24 |
| autoclaving CLD 4/40 [kPa] | | | | | | |
| Humid aged compression set | 5.7 | 33.3 | 8.8 | | | 3.8 |
| CS 50%/22 h/70° C. [%] | | | | | | |
| Humid aged compression set | 7.5 | 72.1 | 65.1 | | | 6.2 |
| CS 75%/22 h/70° C. [%] | | | | | | |
| Humid aged compression set | 22.9 | 93.5 | 33.3 | | | 21.5 |
| CS 70%/22 h/40° C./95% | | | | | | |
| humidity [%] | | | | | | |
| Humid aged load loss | 13.93 | 6.56 | −3.56 | | | 9.97 |
| (CLD 4/40 [kPa]- | | | | | | |
| Compression hardness after | | | | | | |
| autoclaving CLD 4/40 | | | | | | |
| [kPa])/Compression | | | | | | |
| hardness | | | | | | |
| CLD 4/40 [kPa]) | | | | | | |
| HALL [%] | | | | | | |
| Humid aged compression set | 14.5 | 73.9 | 30.3 | | | 14.8 |
| HACS [%] | | | | | | |
| Comment | | | | Collapse | Collapse | |

The test values were determined according to the same DIN standards and procedures as for the MDI-based polyurethane foams.

The experimental data show that the amine-initiated polyols according to the invention are also superior to conventional catalysts in the production of TDI-based flexible polyurethane foam with regard to emissions of volatile organic substances (VOC/FOG) from polyurethane foam. The foam from reference example 17, produced on the basis of emissive catalysts, emitted 288 mg/kg of volatile components. In contrast to this, the emissions from the polyurethane foams with the non-emissive polyols according to the invention were also below the limit of quantification of 1 mg/kg.

In addition, the experimental data show that the polyol according to the invention does not adversely affect the mechanical properties of the flexible polyurethane foams obtained. The values for the humid aging of the flexible polyurethane foam from example 12 according to the invention were also within the desired ranges, in particular from −10% to 20% in the HALL test and from 0 to 40% in the HACS test.

As with the TDI-based polyurethane foams, reference examples 15 and 16 show that not every amine is suitable for the synthesis of a non-emissive polyol because the compositions with these polyols collapsed during foaming and no polyurethane foam was obtained.

Determination of the Catalytic Properties of the Amine-Based Polyols in the Production of TDI-Based Flexible Polyurethane Foam

The catalytic activity was determined by the method described above for the MDI-based flexible polyurethane foams.

TABLE 6
Composition of flexible polyurethane foams for determining
the catalytic properties of amine-based polyols

| | According | | | | |
|---|---|---|---|---|---|
| | to the | | | | |
| HR foam | invention | Reference | | | |
| [parts by weight] | 18 | 19 | 20 | 21 | 22 |
| Polyether polyol | 30.00 | 30.00 | 30.00 | 30.00 | 30.00 |
| SAN-modified polyol | 40.00 | 40.00 | 40.00 | 40.00 | 40.00 |
| Amine-based polyol 1 | 30.00 | — | — | — | — |
| Amine-based polyol 2 | — | 30.00 | — | — | — |
| Amine-based polyol 3 | — | — | 30.00 | — | — |
| Amine-based polyol 4 | — | — | — | 30.00 | — |
| Amine-based polyol 5 | — | — | — | — | 30.00 |
| Water | 3.466 | 3.460 | 3.499 | 3.499 | 3.454 |
| Crosslinker | 0.800 | 0.800 | 0.800 | 0.800 | 0.800 |
| Additive II | 0.60 | 0.60 | 0.60 | 0.60 | 0.60 |
| Isocyanate TDI | 39.50 | 40.29 | 40.42 | 40.42 | 40.12 |
| Index | 100 | 100 | 100 | 100 | 100 |

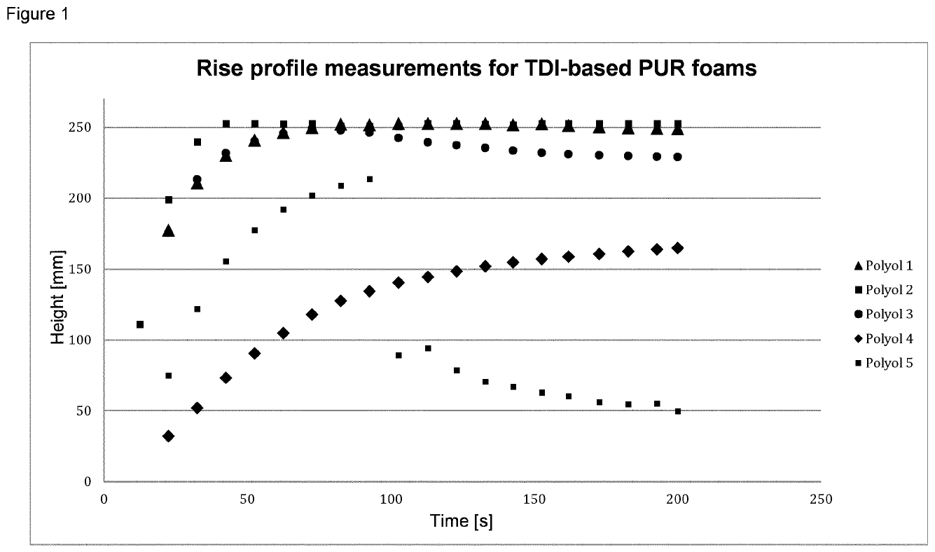

The results of the measurement are shown in FIG. 1.

The advantageous catalytic effect of the amine-initiated polyol 1 according to the invention was even more evident in the production of TDI-based flexible polyurethane foams than in the production of MDI-based flexible polyurethane foams. The TDI-based flexible polyurethane foam from Example 18, which comprised the amine-initiated polyol 1 according to the invention, reached a maximum rise height of 250 mm within only ca. 40 s.

The TDI-based flexible polyurethane foam from reference Example 22 foamed to a height of ca. 220 mm, but then collapsed. The TDI-based flexible polyurethane foam from reference Example 21 only reached a height of ca. 160 mm. These two foams were classified as unusable, collapsed foams.

The results of the rise profile measurements, which allow a conclusion to be drawn about the catalytic effect of the amine-initiated polyols, are summarized in Table 7 below.

TABLE 7
Summary of the catalytic effect of the amine-initiated polyols

| | Amine-initiated | Behavior in | Behavior in |
|---|---|---|---|
| | polyol | MDI foam | TDI foam |
| According to | 1 | ++ | ++ |
| the invention | | | |
| Reference | 2 | + | ++ |
| | | (Very fast, | (Very fast) |
| | | easy to set) | |
| Reference | 3 | + | + |
| | | (easy to set) | (easy to set) |
| Reference | 4 | −− | −− |
| | | (very weak | (very weak |
| | | catalytic activity) | catalytic activity) |
| Reference | 5 | −− | −− |
| | | (weak catalytic | (weak catalytic |
| | | activity, strong | activity, collapse) |
| | | setting) | |

The results of the measurements are shown in FIG. 1.

Overall, the experimental data show that flexible polyurethane foams can be obtained using the amine-initiated polyols according to the invention which, compared to conventional catalysts, have considerable advantages with regard to the emission of volatile substances, while at the same time the mechanical properties remain within the desired value ranges. Furthermore, the amine-initiated polyols according to the invention have good catalytic activities.

1. A process for producing an amine-based polyol for producing flexible polyurethane foam, comprising the following steps
a) reacting an amine of the general formula (I)
R¹₂N—(CH₂)ₙ—NH₂ (I)
where R¹ is in each case a different or the same C₁ to C₁₀ alkyl radical and n is an integer from 1 to 10,
with an epoxide A,
wherein the epoxide A and the amine are used in a molar ratio from 10:1 to 50:1, and
the reaction is conducted until at least 90% by weight of the epoxide A used has reacted, so that an intermediate is obtained,
b) reacting the intermediate with an epoxide B, which is different from epoxide A,
wherein epoxide B is used in an amount which corresponds to a molar ratio of the epoxide to the amine from 8:1 to 40:1, and
the reaction is conducted until at least 90% by weight of the epoxide B used has reacted, so that the amine-based polyol is obtained.

2. The process as claimed in claim 1, wherein, in the amine of the general formula (I), R¹ is in each case the same C₁ to C₃ alkyl radical and n is an integer from 2 to 6.

3. The process as claimed in claim 1, wherein the amine of the general formula (I) is 3-dimethylamino-1-propylamine.

4. The process as claimed in claim 1, wherein the epoxide A is propylene oxide and/or the epoxide B is ethylene oxide.

5. The process as claimed in claim 1, wherein the reaction in steps a) and/or b) is carried out in the presence of a catalyst and/or in steps a) and/or b) and/or after completion of step b) an antioxidant is used.

6. The process as claimed in claim 1, wherein the reaction in step a) is conducted until at least 95% by weight of the epoxide A used has reacted and/or the reaction in step b) is conducted until at least 95% by weight of the epoxide B used has reacted.

7. An amine-based polyol obtained by a process as claimed in claim 1.

8. A method comprising producing flexible polyurethane foam with the amine-based polyol as claimed in claim 7 as a non-emissive catalyst.

9. The method as claimed in claim 8, wherein furniture upholstery, textile inserts, mattresses, automobile seats, headrests, armrests, sponges, roof linings, door side panels, seat covers or structural elements are produced.

10. A flexible polyurethane foam obtained by reacting a composition comprising
an isocyanate-reactive component A1 comprising compounds having isocyanate-reactive hydrogen atoms and/or a filled polyol;
a further isocyanate-reactive component A2, different from A1;
a component A3 comprising at least one blowing agent;
a component B comprising at least one aromatic polyisocyanate; and
a component C comprising an amine-based polyol obtained by a process as claimed in claim 1,
wherein the reaction is carried out at an isocyanate index of 70 to 120.

11. The flexible polyurethane foam as claimed in claim 10, wherein the composition comprises
from 65 to 95 parts by weight of component A1;
from 0.1 to 5 parts by weight of component A2;
from 1 to 4.5 parts by weight of component A3;
from 20 to 70 parts by weight of component B, wherein component B comprises toluene diisocyanate; and
from 5 to 35 parts by weight of component C;
wherein the parts by weight of components A1 and C add up to 100 and the parts by weight of components A2, A3, A4 and B are based on the sum of components A1 and C.

12. The flexible polyurethane foam as claimed in claim 10, wherein the flexible polyurethane foam emits aliphatic amines when measured according to VDA 278 test from 2011, heating for the determination of VOC, of ≤10 mg/kg.

13. The flexible polyurethane foam as claimed in claim 10, wherein the flexible polyurethane foam has a humid aged compression set, 50%/22 h/70° C., in accordance with DIN EN ISO 1856-2008, of 5 to 25%.

14. The flexible polyurethane foam as claimed in claim 10, wherein the flexible polyurethane foam has a humid aged load loss according to DIN EN ISO 3386-1 from 10/2015 of −10 to 20%.

15. The flexible polyurethane foam as claimed in claim 10, wherein the flexible polyurethane foam has a humid aged compression set according to DIN EN 1856 from 2008, after steam autoclaving for 3 hours at 105° C., of 0 to 40%.

16. The process as claimed in claim 2, wherein, in the amine of the general formula (I), R¹ is in each case a methyl radical.

17. The process as claimed in claim 6, wherein the reaction in step a) is conducted until at least 98% by weight, of the epoxide A used has reacted and/or the reaction in step b) is conducted until at least 98% by weight of the epoxide B used has reacted.

18. The method as claimed in claim 8, wherein the method comprises producing flexible polyurethane foam with the amine-based polyol as a non-emissive catalyst in a cold-cure foam process.

19. The flexible polyurethane foam obtained by reacting a composition as claimed in claim 10, wherein the composition further comprises
a component A4 comprising auxiliaries and additives.

20. The flexible polyurethane foam as claimed in claim 11, wherein the composition comprises
from 65 to 95 parts by weight of component A1; wherein component A1 comprises 5 to 60 parts by weight, based on the mass of component A1 and A2, of a filled polyol.
